(19) United States
(12) Patent Application Publication
(10) Pub. No.: US 2021/0168907 A1
(43) Pub. Date: Jun. 3, 2021

(54) Vehicular eat heating and cooling and control therefor

(71) Applicant: Sarkis Allen Arzoumanian, Glendale, CA (US)

(72) Inventor: Sarkis Allen Arzoumanian, Glendale, CA (US)

(73) Assignee: Sarkis Allen Arzoumanian, Glendale, CA (US)

(21) Appl. No.: 16/974,239

(22) Filed: Nov. 25, 2020

Related U.S. Application Data
(60) Provisional application No. 62/974,329, filed on Nov. 29, 2019.

(51) Int. Cl. H05B 1/02; B60N 2/56

(52) U.S. Cl. CPC H05B 1/0238; H05B 1/0225; B60N 2/5678

(57) ABSTRACT

A remotely operated control system for energizing vehicular seat heating and cooling system is shown and described. The novel control system uses a remote control originally intended to operate vehicle features other than seat heating and cooling. The remote control issues more than the necessary single control command within a predetermined time period. The control system preferentially recognizes that the extra signals are intended to operate the seat heating or cooling features. Responsively, power is connected to a selected seat heating or cooling feature. The novel control system is conveniently wired to local electrically energized original conductors of the vehicle electrical system to bring power to the seat heaters or coolers.

### FIELD OF THE INVENTION

The present invention relates to vehicular seat heating and cooling and control thereof.

### BACKGROUND OF THE INVENTION

Passenger automobiles are optionally provided with seat heaters and in some cases, seat coolers by the manufacturer. These accessories are controlled by switches provided by the manufacturer and also built into the vehicle. To initiate operation of a seat heater or cooler, a remote control engine starter is used. For this to successfully initiate heater or cooler operation, the vehicle operator must have remembered to turn the factory proided switch to the “on” position. Also, the vehicle must be in a location suitable for engine operation; that is, in a location ventilated to the outdoors, to preclude potential build-up of exhaust fumes and particularly, carbon monoxide. These conditions are to be considered when starting a seat heating and/or cooling system

A further consideration is that of excessive operation. That is, a system must be prevented from operating indefinitely. One consequence of long term uncontrolled operation is depletion of the vehicle battery. Another consequence is that of localized overheating, which could burn out a heater or potentially cause a fire.

Seat heating and cooling systems may be original to the vehicle or alternatively, provided as an “aftermarket” device, where “aftermarket” refers to an accessory purchased by the vehicle owner or operator separately from purchasing the vehicle. Aftermarket devices may be the product of the vehicle manufacturer, or alternatively, may be the product of an unrelated party.

There exists a need for a control system which works with both vehicle manufacturer and aftermarket seat heating and cooling installations. Another need is to avoid a necessity of turning the engine of the vehicle on when operating seat heaters and coolers. A further need is that of limiting operation of a seat heater or cooler to avoid hazards of excess temperature and battery depletion.

### SUMMARY OF THE INVENTION

The present invention addresses the above identified needs by providing a novel control system which works with pre-existing equipment to expand control options made possible by the pre-existing equipment.

The novel control system may utilize pre-existing features of the vehicle, where these pre-existing features may be either original factory equipment or alternatively, aftermarket equipment. Notably, the novel control system senses command signals ordinarily intended to operate vehicle features to derive a new signal for controlling seat heating and cooling equipment. More particularly, a remote control conventionally controlling pre-existing features such as door locks, vehicle lighting, window position, and others may be exploited to operate the seat heating and cooling equipment. This may be accomplished by varying the number of command signals sent by the remote control from that number used for conventional control. Illustratively, remotely opening door locks, illuminating vehicle running lights and/or headlamps, or opening closed windows typically requires only one command signal. If more than one command signal is sent to a pre-existing feature, the novel control system will read that not as a command to operate the pre-existing feature, but to operate the seat heating and cooling system.

A pre-existing heating and/or cooling switch may be left in the “on” position, so that the vehicle owner or operator is not obliged to remember to leave the switch on each time the vehicle is parked.

A further advantage of the novel control system is that it works with a pre-existing remote control device which may be either factory equipment or alternatively, aftermarket equipment.

The novel control system has a built in timing feature which inhibits seat heating or cooling for more than a predetermined time period. This avoids excessive depletion of the vehicle battery.

The present invention provides improved elements and arrangements thereof by apparatus for the purposes described which is inexpensive, dependable, and fully effective in accomplishing its intended purposes.

These and other objects of the present invention will become readily apparent upon further review of the following specification and drawings.

### BRIEF DESCRIPTION OF THE DRAWINGS

Various objects, features, and attendant advantages of the present invention will become more fully appreciated as the same becomes better understood when considered in conjunction with the accompanying drawings, in which like reference characters designate the same or similar parts throughout the several views, and wherein:

FIG. 1 is a diagrammatic view of a motor vehicle having a seat heater and/or cooler to be controlled by the novel system; and

FIG. 2 is a diagrammatic rendition of a control module and remote controller usable therewith, to control the seat heater and/or cooler of the motor vehicle of FIG. 1.

### DETAILED DESCRIPTION

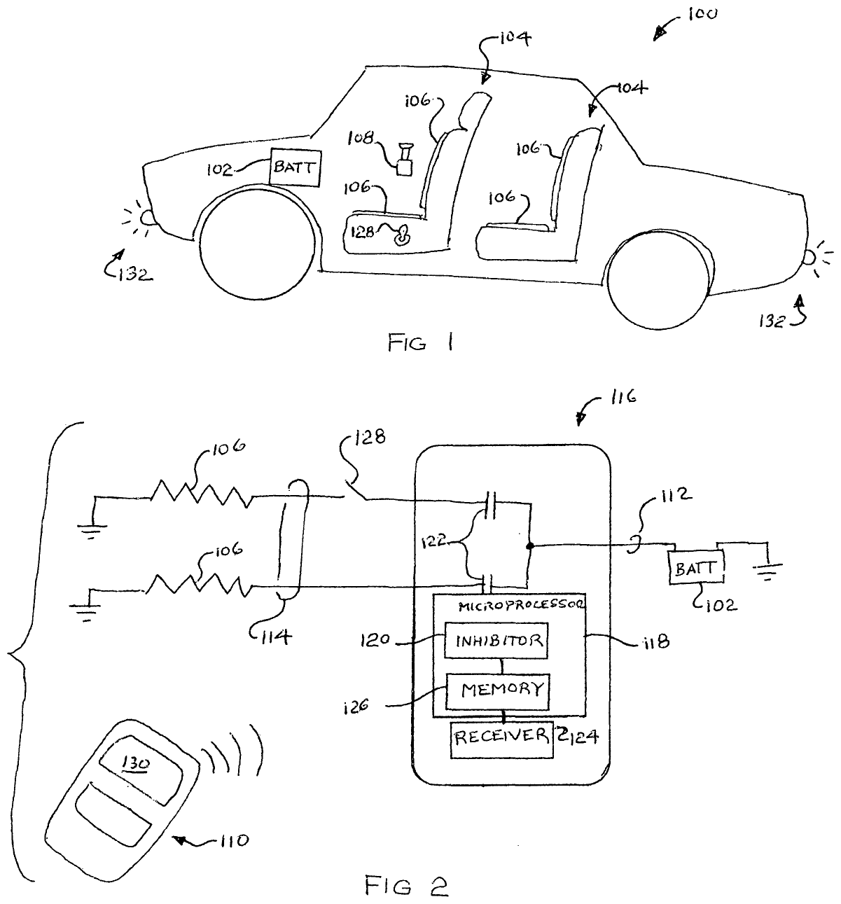

Referring first to FIG. 1, according to at least one aspect of the invention, there is shown a motor vehicle 100, a battery 102, a plurality of seats 104, seat temperature adjusters 106, and a remotely operable original feature 108. Seat temperature adjuster 106 is a seat heater, a seat cooler, or a combination of the two. Reference to seat temperature adjuster 106 may refer to only one such device, or alternatively, to any number of such devices provided to motor vehicle 100. The seat heater may utilize resistive heat, or alternatively, may comprise a convertible hear and cooler such as a thermoelectric heater/cooler function of which can be converted or changed by changing polarity of operating electrical power. Remotely operable original feature 108 is any apparatus provided by the manufacturer of motor vehicle 100 or any apparatus installed on motor vehicle 100 after manufacture and prior to installation of a seat temperature system of the present invention. As depicted herein, the remotely operable original feature 108 is a solenoid operated door lock system, graphically represented as a door lock operator.

In one aspect, the invention is a remotely operable seat temperature system for operating at least one of a seat heating and cooling function of motor vehicle 100 having battery 102, seat temperature adjuster 106, remotely operable original feature 108, and a remote control 110 (see FIG. 2) adapted to control remotely operable original feature 108. The remotely operable seat temperature system may comprise at least one seat temperature adjuster 106, power supply circuitry 112 (see FIG. 2) connected to battery 102 of motor vehicle 100, power output circuitry 114 (see FIG. 2) connected to the at least one seat temperature adjuster 106, and a control module 116. Control module 116 may further comprise a microprocessor 118 including an inhibitor 120 operable to limit operating time of seat temperature adjuster 106, an automatic switch 122 electrically connected to power supply circuitry 112 and power output circuitry 114 to energize power output circuitry 112 by a control signal, and a remote signal receiver 124 communicating with microprocessor 118. Microprocessor 118 may have a memory 126 with computer instructions loaded therein in a non-transitory computer-readable medium that when executed, are configured to instruct microprocessor 118 to connect power output circuitry 114 to electrical power from power supply circuitry 112 responsive to the control signal.

Power supply circuitry 112 and power output circuitry 114 are shown diagrammatically rather than literally, and hence will be understood to include all necessary conductors, switches, and other components to enable operation as described herein.

Control module 116 is shown herein as a discrete or unitary component for convenience of explanation. However, components of control module may be separated from one another if desired. The various components of control module 116 will be understood to include all necessary internal (or optionally, external) connections to enable operation as described.

Inhibitor 120 may comprise a timer (not separately shown) or a sensor (not separately shown), the latter for sensing temperatures achieved by seat temperature adjuster 106. If a predetermined upper or lower temperature is reached, inhibitor 120 is operable to open automatic switch 122, thereby inhibiting further temperature gain or loss by electrical power. Inhibitor 120 also reduces installation of seat temperature adjuster 106 (where not originally provided by the manufacturer of motor vehicle 100) because any wiring or other conductors permanently connected to battery 102 may be exploited for operating power. There is no need to route dedicated supply conductors back to or near battery 102. Also, some sensitive accessory wires that can trigger vehicle computer errors need not be identified or located. Rear seat installation of seat temperature adjusters 106 is facilitated for similar reasons.

Automatic switch 122 may comprise an electromechanical or solid state relay for example.

Remote signal receiver 124 may be conventional, and will be compatible with signals transmitted by remote control 110 (e.g., infrared, radio frequency, or other radiated energy).

Motor vehicle 100 may have a pre-existing manual switch 128 connecting power supply circuitry 112 to power output circuitry 114. Pre-existing manual switch 128 is electrically in series with automatic switch 122.

In summary, the invention has thus far been described as a remotely operable seat temperature system for operating at least one of a seat heating and cooling function of motor vehicle 100.

The invention may include remote controller 110, where motor vehicle 100 does not have a remote controller from the manufacturer or supplied by a supplier of seat temperature adjuster 106, where the latter is an aftermarket product. Alternatively, where either the manufacturer of motor vehicle 100 or the supplier of seat temperature adjuster 106 has provided a remote controller, the invention may omit remote controller 110.

Where a remote controller has been provided by the manufacturer of motor vehicle 100 or by the supplier of seat temperature adjuster 106, operation of control module may be determined by the number of signal pulses employed. Ordinarily, a user presses a button (e.g., button 130 in FIG. 2) to operate remotely operable original feature 108. This action sends a singular signal or pulse to motor vehicle 100. Software in memory 126 is arranged to ignore a singular signal or pulse. For purposes of the invention, remote control 110 is operated to generate more than one signal or pulse within a predetermined time interval (e.g., four seconds). The software in memory 126 reads plural signals actively, in that plural signals are recognized to operate seat temperature adjuster 106. Two signals or pulses may operate seat temperature adjuster 106 for example. The system may optionally be arranged to require more than two signals or pulses. For example, it is possible that a human user using remote control 110 will be distracted and lose count of signals, or may be interrupted by other people, environmental objects, and other influences which might cause that user to inadvertently press button 130 more than once. To forestall unintended operation of seat temperature adjuster 106, then, the system may be arranged to respond only to three signals or pulses, or another number of signals or pulses.

The number of pulses or signals may be used by the system for other purposes. For example, more than a minimum number of pulses in the time interval may be used for progressive (increasing or decreasing) levels of temperature adjustment. Alternatively, the number of pulses in the time interval may be used to activate additional seat temperature adjusters 106, where more than one is provided (and as shown in FIG. 1 for example).

The invention may also be understood to comprise seat temperature adjuster(s) 106 in combination with a control system therefor. The combination may or may not include remote control 110.

The invention may also be thought of as a pulse controlled seat temperature system for operating at least one of a seat heating and cooling function of motor vehicle 100 having battery 102, seat temperature adjuster 106, remotely operable original feature 108, and remote control 110 adapted to control remotely operable original feature 108. The remotely operable seat temperature system may comprise control module 116 further comprising power supply circuitry 112, power output circuitry 114, microprocessor 118 connected to power supply circuitry 112 and to power output circuitry 114, inhibitor 120 operable to limit operating time of seat temperature adjuster 106, automatic switch 122 electrically connected to power supply circuitry 112 and to power output circuitry 114, and remote signal receiver 124 communicating with microprocessor 18, wherein microprocessor 118 has installed in memory 126 computer instructions loaded therein in a non-transitory computer-readable medium that when executed, are configured to instruct microprocessor 118 to connect power output circuitry 114 to electrical power from power supply circuitry 112 responsive to a control signal. The control signal is that generated by remote control 110, and includes pulses a count of which has different meanings to the software in memory 126. The control system in this latter understanding of the invention would vary the number of seat temperature adjusters 106 which are activated, and/or will vary the degree of temperature adjustment, all responsive to pulse count within the predetermined time interval.

In this understanding of the invention, the pulse controlled seat temperature system may further comprise remote control 110 adapted to provide command signals to control module 116 via remote signal receiver 124.

A further feature which is optionally provided is confirmation of operation of seat temperature adjuster 106. Initiation of operation can be signaled by control module 116 by for example running lights 132 (or by other lights or by horn).

While the present invention has been described in connection with what is considered the most practical and preferred embodiment, it is to be understood that the present invention is not to be limited to the disclosed arrangements, but is intended to cover various arrangements which are included within the spirit and scope of the broadest possible interpretation of the appended claims so as to encompass all modifications and equivalent arrangements which are possible.

I claim:

1. A remotely operable seat temperature system for operating at least one of a seat heating and cooling function of a motor vehicle having a battery, a seat temperature adjuster, a remotely operable original feature, and a remote control adapted to control the remotely operable original feature, the remotely operable seat temperature system comprising:
at least one seat temperature adjuster;
power supply circuitry connected to the battery of the motor vehicle;
power output circuitry connected to the at least one seat temperature adjuster; and
a control module further comprising
a microprocessor including an inhibitor operable to limit operating time of the seat temperature adjuster,
an automatic switch electrically connected to the power supply circuitry and the power output circuitry to energize the power output circuitry by a control signal,
a remote signal receiver communicating with the microprocessor, wherein the microprocessor has installed in the memory computer instructions loaded therein in a non-transitory computer-readable medium that when executed, are configured to instruct the microprocessor to connect the power output circuitry to electrical power from the power supply circuitry responsive to the control signal.

2. The remotely operable seat temperature system of claim 1, wherein the motor vehicle has a pre-existing manual switch connecting the power supply circuitry to the power output circuitry, wherein the pre-existing manual switch is electrically in series with the automatic switch.

3. A pulse controlled seat temperature system for operating at least one of a seat heating and cooling function of a motor vehicle having a battery, a seat temperature adjuster, a remotely operable original feature, and a remote control adapted to control the remotely operable original feature, the remotely operable seat temperature system comprising:
a control module further comprising:
power supply circuitry;
power output circuitry;
a microprocessor connected to the power supply circuitry and to the power output circuitry;
an inhibitor operable to limit operating time of the seat temperature adjuster,
an automatic switch electrically connected to the power supply circuitry and to the power output circuitry,
a remote signal receiver communicating with the microprocessor, wherein the microprocessor has installed in the memory computer instructions loaded therein in a non-transitory computer-readable medium that when executed, are configured to instruct the microprocessor to connect the power output circuitry to electrical power from the power supply circuitry responsive to a control signal.

4. The pulse controlled seat temperature system of claim 3, further comprising a remote control adapted to provide command signals to the control module via the remote signal receiver.
